(19) United States
(12) Patent Application Publication
(10) Pub. No.: US 2013/0069422 A1
(43) Pub. Date: Mar. 21, 2013

(54) MULTI-PIECE WHEEL ASSEMBLY FOR TOY VEHICLES

(71) Applicant: Jack LI, Walnut, CA (US)

(72) Inventor: Jack LI, Walnut, CA (US)

(73) Assignee: JADA TOYS, INC., City of Industry, CA (US)

(21) Appl. No.: 13/621,814

(22) Filed: Sep. 17, 2012

Related U.S. Application Data
(60) Provisional application No. 61/535,157, filed on Sep. 15, 2011.

(51) Int. Cl. B60B 1/06

(52) U.S. Cl. CPC B60B 1/06
USPC 301/104

(57) ABSTRACT

A wheel for a toy vehicle including a rim comprising at least one spoke radiating from a hub comprising a channel, and an insert configured to be disposed in the channel, wherein the insert is held within the channel such that the insert appears to be integral with the at least one spoke.

### CROSS-REFERENCE TO RELATED APPLICATION

This Application claims priority from U.S. Provisional Application Ser. No. 61/535,157, filed Sep. 15, 2011, the contents of which are hereby incorporated by reference herein in its entirety.

### BACKGROUND

1. Field

Aspects of the present disclosure relate generally to wheel assemblies, and more specifically to multi-piece wheel assemblies for toy vehicles.

2. Background

In certain configurations, wheels for toy vehicles may be configured to have different colors. For example, a wheel of a particular vehicle may have a plurality of spokes, and it may be desirable to have each of those spokes be of a certain color or finish. However, these colors or finishes typically have to be painted or printed on the wheel itself. Regardless of which process is used, both the painting and printing process need to be precise, otherwise color or finish alignment will be off

Consequently, it would be desirable to address the issues discussed above.

### SUMMARY

Various aspects of a multi-piece wheel assembly may be disclosed herein, where in one aspect of a disclosed approach, the multi-piece wheel assembly includes at least two pieces. A first piece may be a body of the wheel itself, while the second piece may be a decorative piece that may be assembled to the body to create a wheel with certain decorative features or finishes.

Other aspects of the multi-piece wheel assembly may be disclosed herein.

### BRIEF DESCRIPTION OF THE DRAWINGS

FIG. 1 is an exploded view of a multi-piece wheel assembly illustrating various parts of the rim;

FIG. 2 is a perspective view of the multi-piece wheel assembly of FIG. 1, after the various parts of the wheel have been assembled;

FIG. 3 is a top plan view of the multi-piece wheel assembly of FIG. 1, after the various parts of the wheel have been assembled;

FIG. 4 is a cross-section view of the multi-piece wheel assembly of FIG. 1 taken along line VI-VI in FIG. 3, after the various parts of the wheel have been assembled and secured in accordance with one approach of the present invention;

FIG. 5 is an exploded cross-section view of the multi-piece wheel assembly of FIG. 4, before the various parts of the wheel have been assembled and secured;

FIG. 6 is an exploded cross-section view of the multi-piece wheel assembly of FIG. 4, after the various parts of the wheel have been assembled, but before they have been secured to each other as in FIG. 4;

FIG. 7 is a cross-section view of the multi-piece wheel assembly of FIG. 1 taken along line VI-VI of FIG. 3, after the various parts of the wheel have been assembled and secured in accordance with another approach of the present invention; and

FIG. 8 is an exploded cross-section view of the multi-piece wheel assembly of FIG. 7, before the various parts of the wheel have been assembled and secured in accordance with the other approach of the present invention in FIG. 7.

### DETAILED DESCRIPTION

The detailed description set forth below in connection with the appended drawings is intended as a description of various configurations and is not intended to represent the only configurations in which the concepts described therein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

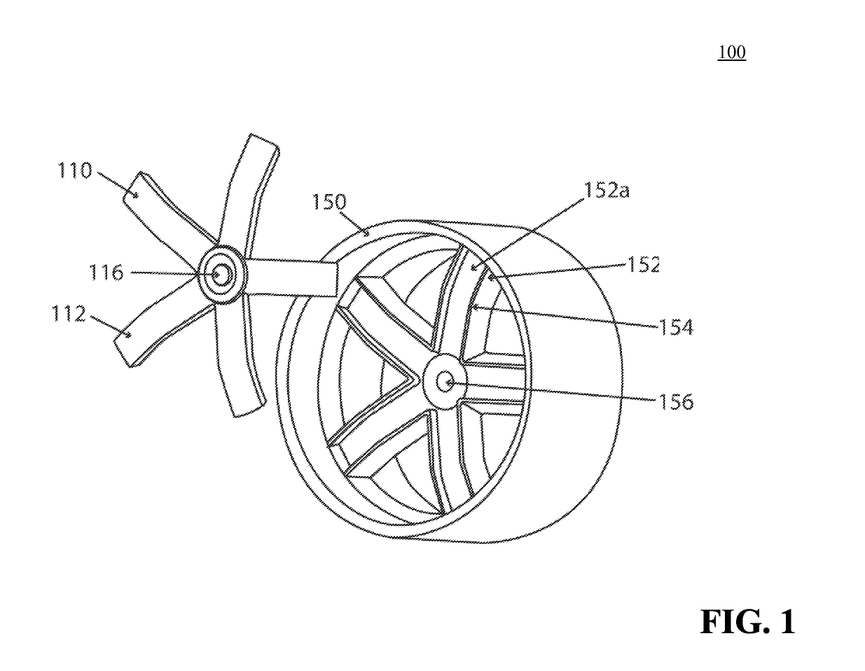

FIG. 1 illustrates various parts of a multi-piece wheel assembly 100 configured in accordance with one embodiment of the present invention. The exemplary multi-piece rim assembly 100 includes a rim 150 and a rim insert 110. As shown in FIG. 1, the rim 150 includes a hub 156 and a plurality of spokes 152 that radiates from the hub 156. The shape and form of the rim 150 may vary with the various embodiments of the invention. For example, the number of spokes may be of any number that is sufficient to support the rim 150. The shape of the spokes may also vary so as to be curved or have different geometric shapes.

Each spoke in the plurality of spokes 152 of the rim 150 includes a recessed portion 152a for receiving a respective arm 112 from an insert 110. In one aspect of the invention, the plurality of spokes 152 each includes borders 154. Each respective arm portion radiates from a center 116. The insert 110 may be secured in the rim 150 in a variety of manners, as further described herein. Also, the insert 110 may have a different color than the rim 150. In one aspect of the invention, the insert 110 may be molded from a material that is of a different color from the rim 150. In another aspect, the insert 110 may be pre-painted before being mounted to the rim 150. Thus, instead of having to apply paint to the spokes of a wheel, the spokes may be pre-painted or otherwise pre-configured in a different color. Once mounted to the rim 150, the insert 110 may appear to be integrated in the rim 150 and not appear to be a separate part. Further, in addition to having a different color, the insert 110 may also have a different shape or texture, such as different finishes.

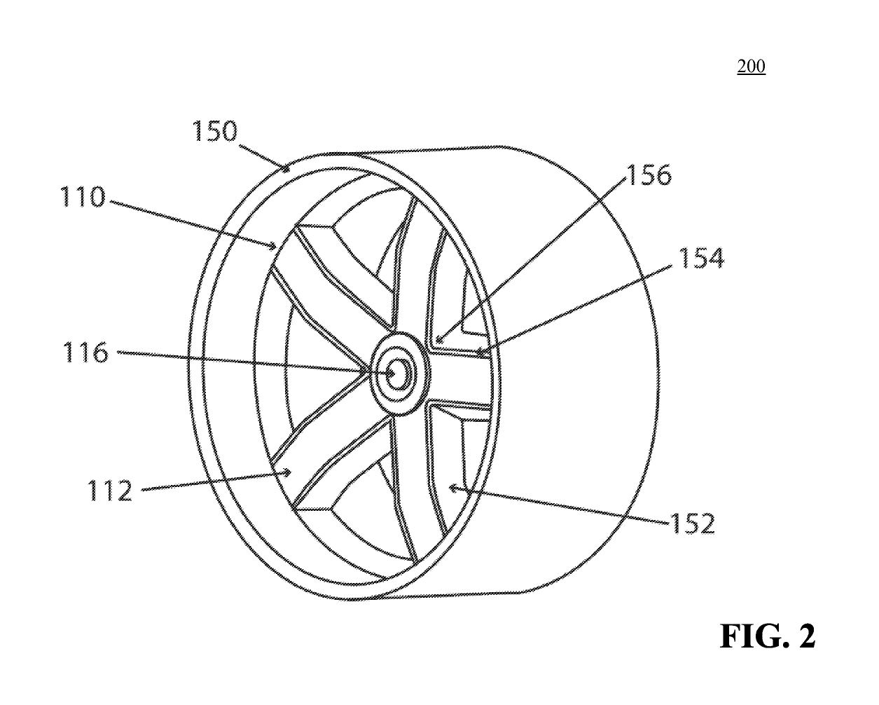

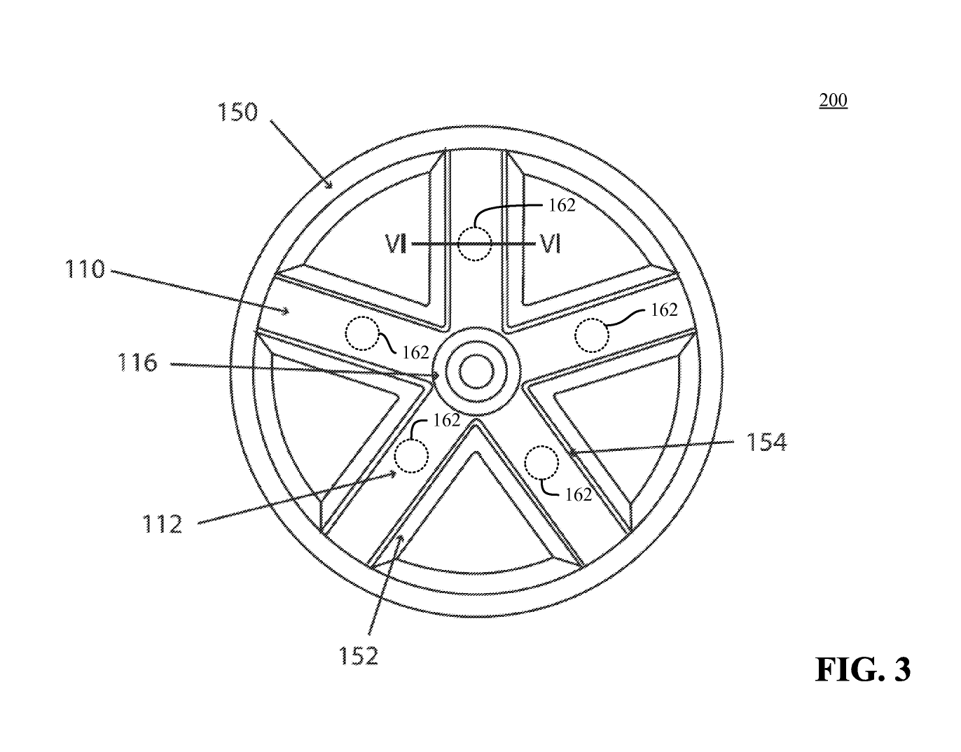

Referring now to FIG. 2, which is a perspective view of an assembled multi-piece wheel assembly 200, it may be seen that the insert 100 has been placed onto the rim 150. Also referring to FIG. 3, which is a top plan view of the assembled multi-piece wheel assembly 200, it may be seen that the insert 110 is aligned with the rim 150 such that each of the plurality of arms 112 is disposed in each recessed portion 152a of the plurality of spokes 152. In one aspect of the invention, and as further detailed below, the insert 110 may be coupled to the rim 150 by having an extruded portion of each of the plurality of arms 112 being inserted into a respective through-hole 162. The extruded portion may then be able to be secured by melting part of the extruded portion, gluing the extruded portion, or fastening the extruded portion using a fastener such as a screw. As disclosed above, once assembled, the insert 110 and the rim 150 appear to be integrated and formed from one piece of material, such as appearing being molded from one piece of plastic.

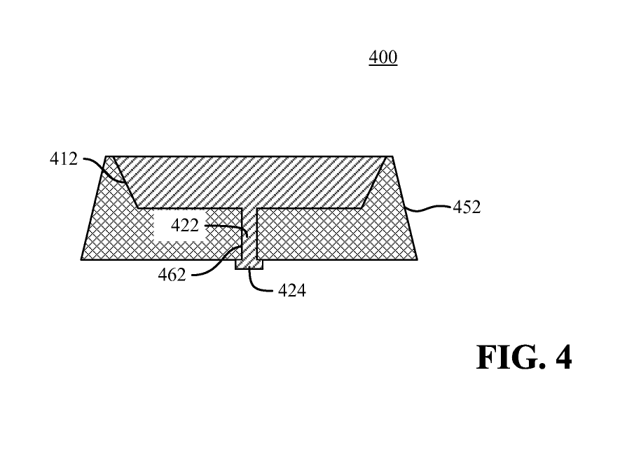

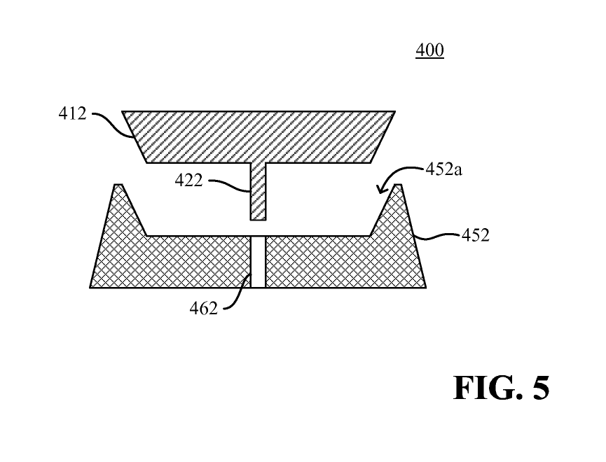

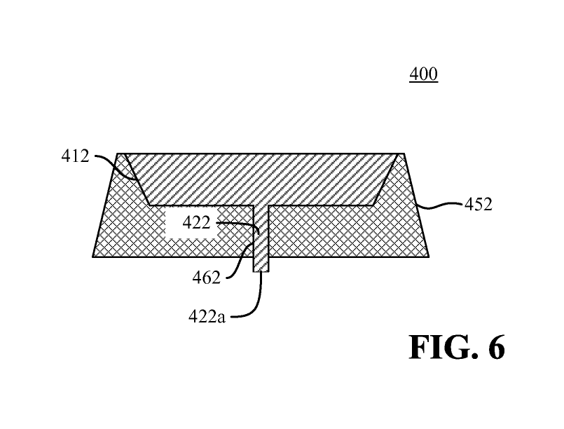

FIG. 4 illustrates one embodiment of a cross-section 400 of the assembled multi-piece wheel assembly 200 taken across line VI-VI of FIG. 3, where an arm 412 such as one of the arms 112 from the insert 110 has been secured into a spoke 452 such as one of the plurality of spokes 152. In one aspect of the embodiment, the arm 412 is secured into the spoke 452 via an extrusion 422 that is inserted through a through-hole 462 in the spoke 452 similar to the through-holes 162 in the plurality of spokes 152. The extrusion 422 includes a stopper portion 424 that is larger than the diameter of the through-hole 462. In this aspect of the invention, referring to FIGS. 5 and 6, the stopper portion 424 is formed from the extrusion 422 of the arm 412 being inserted into the through-hole 462 of the spoke 452 (see FIG. 5), where the arm 412 seats in a recess 452a of the spoke 452 after the extrusion 422 has been inserted. The stopper portion 424 is formed by melting an exposed version 422a of the extrusion 422 just enough to create the stopper portion 424 (see FIG. 6).

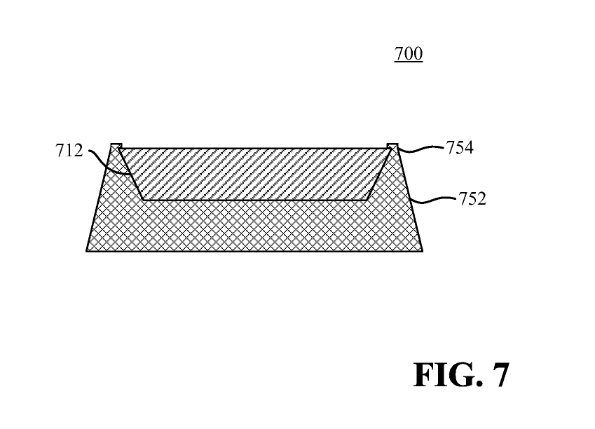

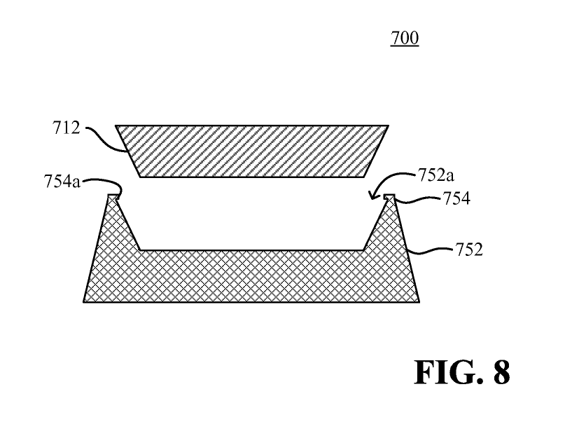

FIG. 7 illustrates another embodiment of a cross-section 700 of the assembled multi-piece wheel assembly 200 taken across line VI-VI of FIG. 3, where an arm 712 such as one of the arms 112 from the insert 110 has been secured into a spoke 752 such as one of the plurality of spokes 152. FIG. 8 illustrates the arm 712 before assembly into the spoke 752. In one aspect of the embodiment, the arm 712 is secured into the spoke 752 via retaining portions 754a on borders 754 such as borders 154. The spoke 752 includes a recessed portion 752a. The arm 712 is snapped into the recess portion 752a of the spoke 752 and is retained by the retaining portions 754a. The retaining portions 754a thus protrude sufficiently from the borders 754 to retain the arm 712, but do not protrude to an extent that significantly interferes with the arm 712 with being snapped into the spoke 752. The retaining portions 754a is also slanted on the top portion to guide the arm 712 to be pushed down. Those skilled in the art will be able to determine at least one appropriate size and shape of the retaining portions 754a.

In various aspects of the current invention, multiple inserts may be used to achieve the desired result. Thus, for example, a different insert may be used with each of the plurality of spokes 152. Further, each of the multiple inserts may be configured to be of a different shape, color, or finish.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A wheel comprising:
a rim comprising at least one spoke radiating from a hub comprising a channel; and
an insert configured to be disposed in the channel,
wherein the insert is held within the channel such that the insert appears to be integral with the at least one spoke.

2. The wheel of claim 1, wherein the channel of the at least one spoke further comprises at least one border and the insert being aligned within the channel via the at least one border.

3. The wheel of claim 2, wherein the at least one border is comprised to retain the insert.

4. The wheel of claim 1, wherein the at least one spoke further comprises at least one through-hole and the insert comprises an extruded portion configured to fit in the at least one through-hole.

5. The wheel of claim 4, wherein part of the extruded portion that is exposed from the at least one through-hole is melted.

6. The wheel of claim 4, wherein a fastener is secured to the extruded portion that is exposed from the at least one through-hole.

7. The wheel of claim 4, further comprising an adhesive configured to secure the extruded portion to the at least one through-hole.
